(19) United States
(12) Patent Application Publication
(10) Pub. No.: US 2009/0158284 A1
(43) Pub. Date: Jun. 18, 2009

(54) SYSTEM AND METHOD OF PROCESSING SENDER REQUESTS FOR REMOTE REPLICATION

(75) Inventors: Ming-Hao BI, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 11/959,138

(22) Filed: Dec. 18, 2007

(51) Int. Cl. G06F 9/305

(52) U.S. Cl. 718/102

(57) ABSTRACT

A system and a method of processing sender requests for remote replication are applied in local system having a plurality of network block devices (NBD). A fixed number of sender threads are created in local system to form sender thread pool. All NBDs receiving write request for corresponding remote mirror volume are serially connected to be circular linked list. A pointer is set to sequentially record latest processed NBD in circular linked list, the sender threads in the sender thread pool are allocated to actively search NBD to be processed pointed by the pointer according to a sequence in circular linked list, and processing of NBD pointed by the pointer is locked by using the sender thread, hence processing the sender request of NBD. Each time when the sender request is finished, the pointer is sequentially moved to next NBD and the sender request of corresponding NBD is performed.

### BACKGROUND OF THE INVENTION

1. Field of Invention

The present invention relates to a system and a method of allocating resources for remote replication, and more particularly to a system and a method of allocating sender threads for remote replication applied in network block devices (NBDs).

2. Related Art

As application enhances requirements on service continuity and users pay more attention to data security, a real-time remote replication technology has been developed accordingly and concerned widely in a short period. The real-time remote replication technology may be used to establish a data mirror at a remote terminal in real time without interrupting application, thereby protecting data from losing or being damaged to cause a data disaster as far as possible.

However, most of products and technologies base on sync to send data. When there are multiple remote replication requests, other requests have to wait in series before one sender request is processed, thereby affecting a system in processing and responding requests and its efficiency. Therefore, the conventional art has proposed a solution of sending multiple threads in an asynchronous manner, which one thread receives new requests and multiple threads send received requests. The realization of the asynchronous manner must involve multi-thread concurrency. At present, the solution which is simplest and may be realized easily is binding exclusive kernel sender threads 12, 14, and 16 respectively for remote mirror volumes 22, 24, and 26 in a remote system 20, which each of the remote mirror volumes corresponds to one NBD, and the sender threads in the local system 10 are responsible for sending I/O requests to the corresponding remote mirror volumes, as shown in FIG. 1.

This method has two latent problems, one is that a large amount of kernel threads will be generated once the system has a large amount of NBDs, resulting in increased system pressure and more occupied resources; the other is that the allocation of the resources can hardly be controlled and the execution of a kernel thread is under control of a Linux kernel and can hardly be controlled by us. That is, after each of the NBDs starts a thread, all subsequent procedures are determined by the Linux kernel once starting the execution. Therefore, which device sends data, how much of data is sent, and when to send are unexpected at all.

Furthermore, since all the copy operations in the system involve network communication, such operations will contend for network resources. Therefore, some methods must be adopted to balance network usage in the system.

### SUMMARY OF THE INVENTION

In order to solve the problems and defects in the conventional art, the present invention is directed to provide a system and a method of processing sender requests for remote replication, which is applied in a local system having a plurality of NBDs, so as to send data with multiple threads in an asynchronous manner, thereby not only enhancing the processing and responding ability of the devices and reducing system resource consumption caused by multiple threads when a large amount of remote mirror volumes exist.

The system of processing sender requests for remote replication provided by the present invention includes a creation module, a linked list module, a pointer module, a thread allocation module, a request receiving module, and a request processing module. The creation module is used to create a fixed number of sender threads in a local system, so as to form a sender thread pool. The linked list module is used to serially connect all NBDs receiving a write request for a corresponding remote mirror volume to be a circular linked list. The pointer module sets a pointer to sequentially record a latest processed NBD in the circular linked list and sequentially move the pointer to the next NBD according to the sequence of the NBDs in the circular linked list each time when the sender request of the latest processed NBD is finished, in which a start position of the pointer points to a list head of the circular linked list. The thread allocation module is used to allocate the sender threads in the sender thread pool, so as to actively search the next NBD to be processed. The request receiving module is responsible for receiving a new sender request and adding the new sender request to a sender request queue of a corresponding NBD. The request processing module locks the processing of the NBD pointed by the pointer by using the sender thread, and processes the sender request of the NBD.

Regarding the fact that one or more remote mirror volumes are created in each original volume in the local system, the sender request processing system provided by the present invention further includes a weight module for setting a sender request weight for each of the original volumes in the local system, so as to allocate a batch size of the sender requests for the NBDs of each original volume to the corresponding remote mirror volumes.

Furthermore, the method of processing sender requests for remote replication provided by the present invention is applied in a local system having a plurality of NBDs and includes: creating a fixed number of sender threads in the local system, so as to form a sender thread pool; serially connecting all the NBDs receiving a write request for a corresponding remote mirror volume to be a circular linked list; setting a pointer to sequentially record a latest processed NBD in the circular linked list, in which a start position of the pointer points to a list head of the circular linked list; allocating the sender threads in the sender thread pool, so as to actively search the NBD to be processed pointed by the pointer according to a sequence in the circular linked list; locking the processing of the NBD pointed by the pointer by using the sender thread, and processing the sender request of the NBD; and according to the sequence of the NBDs in the circular linked list, each time when the sender request is finished, sequentially moving the pointer to a next NBD and executing the sender request of the corresponding NBD.

Regarding the fact that one or more remote mirror volumes are created in each original volume in the local system, the sender request processing method provided by the present invention further includes setting a sender request weight for each of the original volumes in the local system, so as to allocate a batch size of the sender requests for the NBDs of each original volume to the remote mirror volumes.

The present invention creates a fixed number of sender threads to process more sender requests of the NBDs to the remote mirrors, so as to realize the data sending with multiple threads in an asynchronous manner, thereby not only enhancing the processing and responding ability of the devices and reducing system resource consumption caused by multiple threads when a large amount of remote mirror volumes exist. Furthermore, the sender request weight of each original volume is set to control the sending process and resource occupation in a certain extent.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the structure of processing sender requests for remote replication in the conventional art;

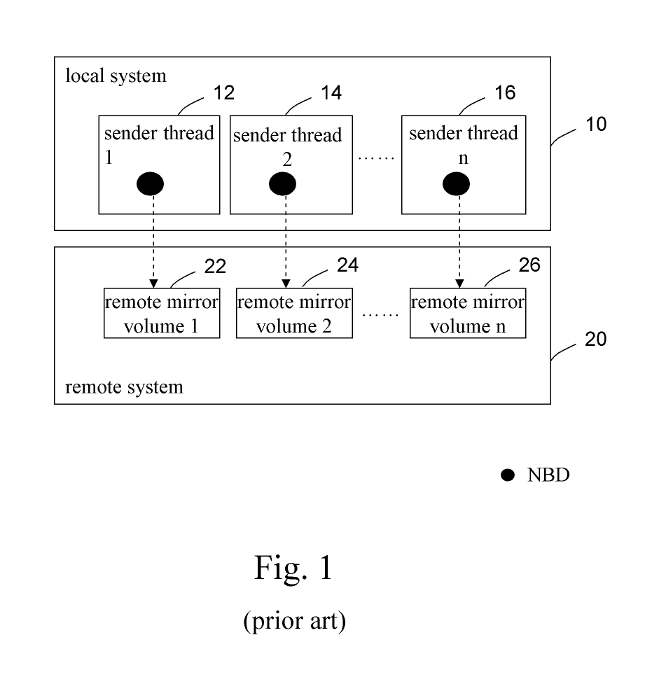

FIG. 2 is a schematic view of the structure of processing sender requests for remote replication according to a first embodiment of the present invention;

FIG. 3 is a schematic view of the structure of processing sender requests for remote replication according to a second embodiment of the present invention;

FIG. 4 is a flow chart of the steps of the method of processing sender requests for remote replication according to the first embodiment of the present invention; and

FIG. 5 is a flow chart of the steps of the method of processing sender requests for remote replication according to the second embodiment of the present invention.

### DETAILED DESCRIPTION OF THE INVENTION

The features and practice of the preferred embodiments of the present invention will be illustrated below in detail with reference to the drawings.

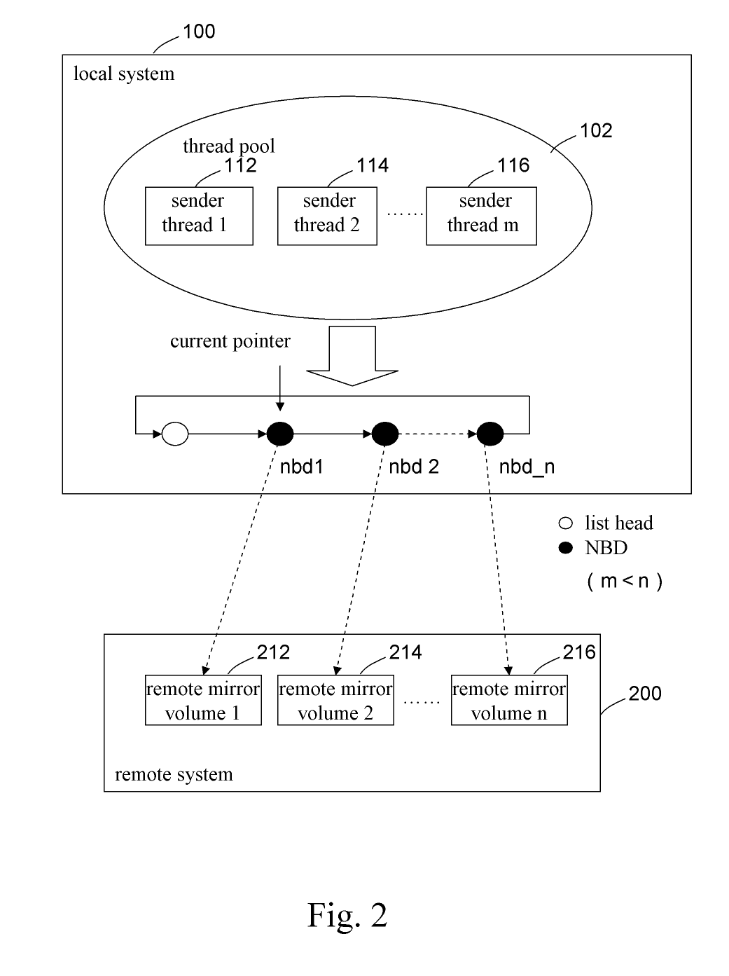

The sender request processing system provided by the present invention includes a creation module, a linked list module, a pointer module, a thread allocation module, a request receiving module, and a request processing module. Referring to FIG. 2, the composition and principle of the system of processing sender requests for remote replication provided by the present invention will be illustrated in detail below. FIG. 2 is a schematic view of the structure of processing sender requests for remote replication according to a first embodiment of the present invention. The creation module creates a fixed number of (e.g., m) sender threads 112, 114, 116 . . . in a local system 100 to form a sender thread pool 102. In this embodiment, the sender threads are allocated by using a remote mirror volume as a unit, i.e., only one network block device (NBD) is created in each original volume of the local system 100, and each remote mirror volume merely corresponds to one NBD.

The linked list module is used to serially connect all the NBDs nbd1, nbd2, nbd_n (the number is n) receiving a write request to the corresponding remote mirror volumes 212, 214, 216 (the number is n) in a remote system 200 to be a circular linked list. The pointer module is used to set a pointer to sequentially record a latest processed NBD in the circular linked list, and a start position of the pointer points to list head of the circular linked list.

The thread allocation module is used to dynamically allocate the sender threads in the thread pool 102, so as to actively search the NBD to be processed pointed by the pointer according to a sequence in the circular linked list.

The principle for the thread allocation module to allocate the sender threads and actively search the node of the NBD to be processed is as follows. In each processing cycle, the sender thread moves the pointer pointing to the NBD which is being processed, and then determines whether there are other threads processing the current pointed device. If yes, the procedure enters the next cycle, and if no, the request of the NBD is processed. After the processing is finished, the procedure enters the next cycle. As such, the sender threads are always working and will not wait until there are no NBD in a queue to be processed.

The sender request processing system provided by the present invention further includes a request receiving module responsible for receiving a new sender request, making response, and adding the new sender request to the sender request queue of the corresponding NBD. The request processing module processes the sender request of a NBD in the linked list to the corresponding remote mirror volume by using the sender thread. When the sender thread performs operation, firstly whether the device linked list is empty is determined, and if it is empty, it is represented that the latest processed NBD currently pointed by the pointer is still followed by NBDs with unprocessed requests. Therefore, the pointer module moves the pointer to the next NBD. The request processing module locks the processing of the NBD by using the sender thread, so as to only process the sender queue of the NBD pointed by the pointer at this time.

Each time when the request processing module finishes the sender request of the latest processed NBD, the determining operation of the linked list is repeated in the same manner, and correspondingly, the pointer module, according to a sequence of the NBDs in the circular linked list, sequentially moves the pointer to the next NBD, so as to position the request which will be processed next. The procedure is ended till the linked list is empty, i.e., when the sender requests in all the NBDs in the linked list are processed.

Data may be sent in an asynchronous manner by using the sender request processing system, the multithreading method enhances the processing ability in a certain extent, and the recourse consumption is reduced when a large amount of NBDs exist. Since the request queue is locked when being processed each time, the problem that multiple threads process one request queue of the NBD in sync will not occur, thereby ensuring the time order of data and also ensuring that each of the NBDs has substantially the same opportunity to be processed.

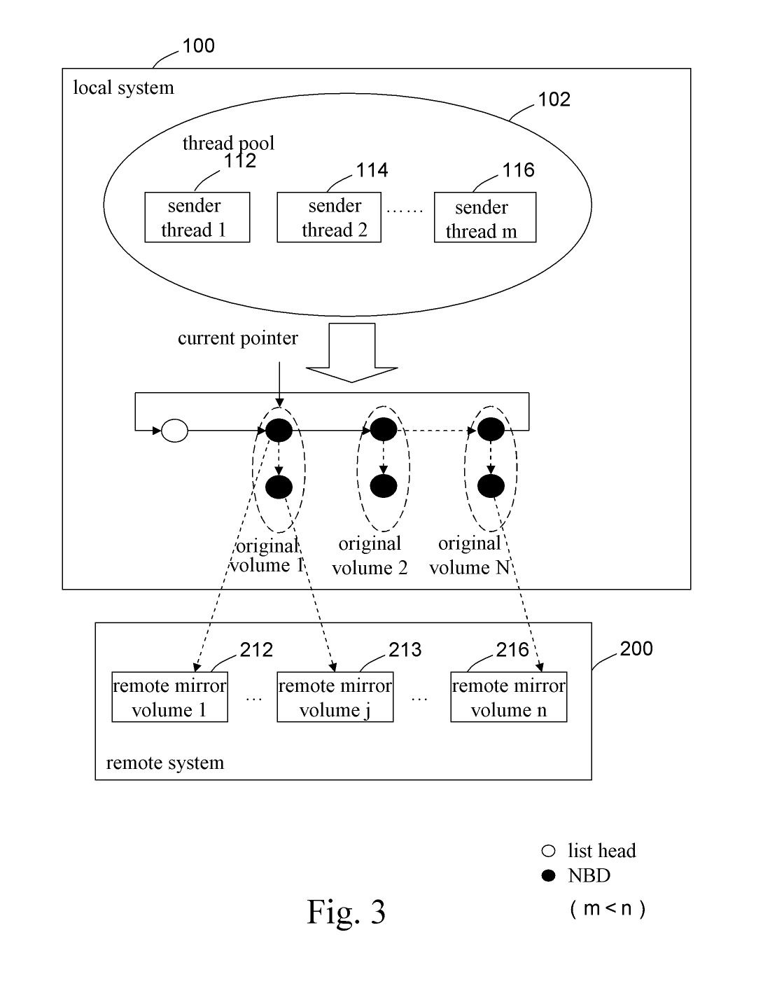

Referring to FIG. 3, a schematic view of the structure of processing sender requests for remote replication according to a second embodiment of the present invention is shown. Different from the first embodiment, this embodiment is applied in the local system 100 in which multiple remote mirror volumes are created in each original volume (each remote mirror volume corresponds to one NBD). That is, as shown in FIG. 3, the local system 100 includes the original volume 1, the original volume 2, . . . , the original volume N, and each of the original volumes includes multiple NBDs, so as to correspond to the created multiple remote mirror volumes. For example, the NBDs in the original volume 1 correspond to j mirror volumes between the remote mirror volume 212 and the remote mirror volume 213, and the NBDs included in the total N original volumes correspond to n remote mirror volumes including the remote mirror volume 216.

When a certain original volume has a large amount of remote mirror volumes, the sender threads merely may process the sender requests of the NBDs corresponding to the remote mirror volumes in the same original volume under most circumstances. Therefore, other original volumes have few opportunities to be processed. At this point, the sender threads are allocated by using the original volume as a unit in this embodiment, so as to make all remote mirror volumes of the original volumes have the same opportunity to be processed.

Therefore, the linked list module serially connects the NBDs corresponding to multiple remote mirror volumes of the same original volume to be a queue linked list. Then, the original volumes each including multiple serially connected queue linked lists are serially connected to be a circular linked list. When executing the sender threads, the request processing module firstly determines whether the device linked list is empty, and if the linked list is empty, the request processing module sequentially processes the sender requests of the multiple NBDs in the queue linked list to the remote mirror volumes under the locked status. The same as the first embodiment, the pointer module uses the pointer to record the queue linked list of NBDs under a certain current latest processed original volume, and after finishing the sender requests of the multiple NBDs in the queue linked list, the pointer module backward moves the pointer to a next queue linked list including the NBDs corresponding to the multiple remote mirror volumes in the same original volume.

The same as the first embodiment, each time when the request processing module finishes the sender requests in the queue linked list of the NBDs under a certain latest processed original volume, the determining operation of the linked list is repeated in the same manner, and according to the sequence of the original volumes in the circular linked list, the pointer module sequentially moves the pointer to a next queue linked list of the NBDs corresponding to the multiple remote mirror volumes of the same original volume, so as to position the request to be processed till the linked list is empty, i.e., till the sender requests of all the NBDs in the linked list are processed.

In addition, the sender request processing system provided by the present invention further includes a weight module to set sender request weight for each original volume in the local system 100, thereby allocating a batch size of the sender requests for the NBDs of each original volume to the corresponding remote mirror volumes. The method of processing the sender threads is substantially the same as that in the first embodiment, but each time after the current pointer is moved, one unit of the requests of all remote mirror volumes of the same original volume is sequentially processed and then the procedure enters the next position. Herein, a unit value depends on the weight set for the original volume, and if the weight is increased, it is represented that there are more resources allocated for the original volume.

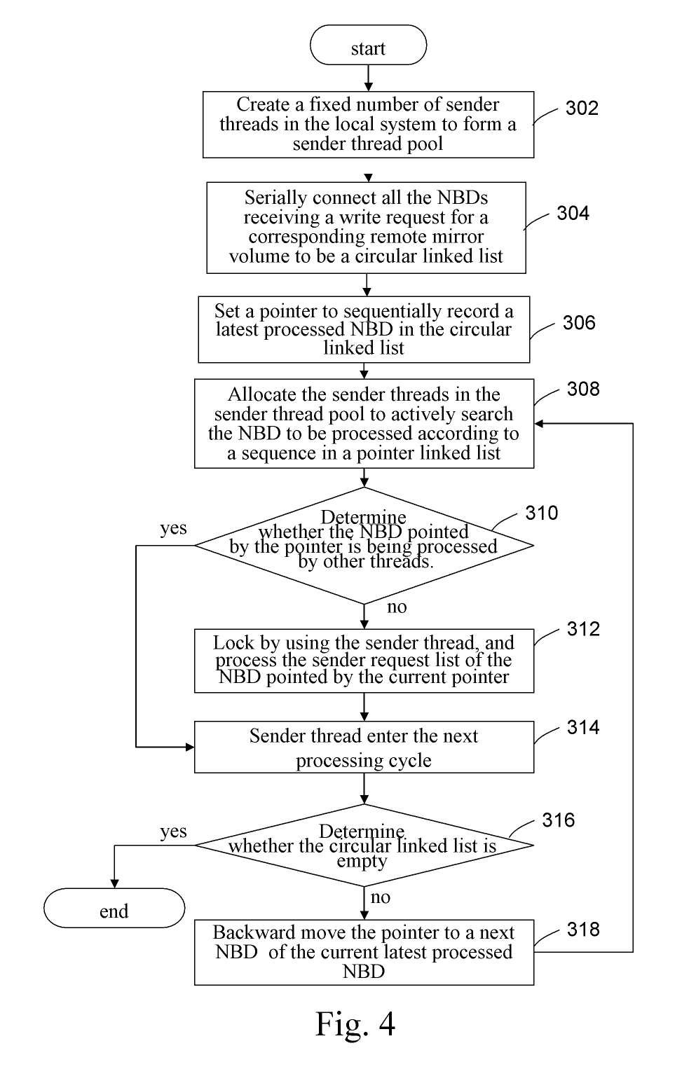

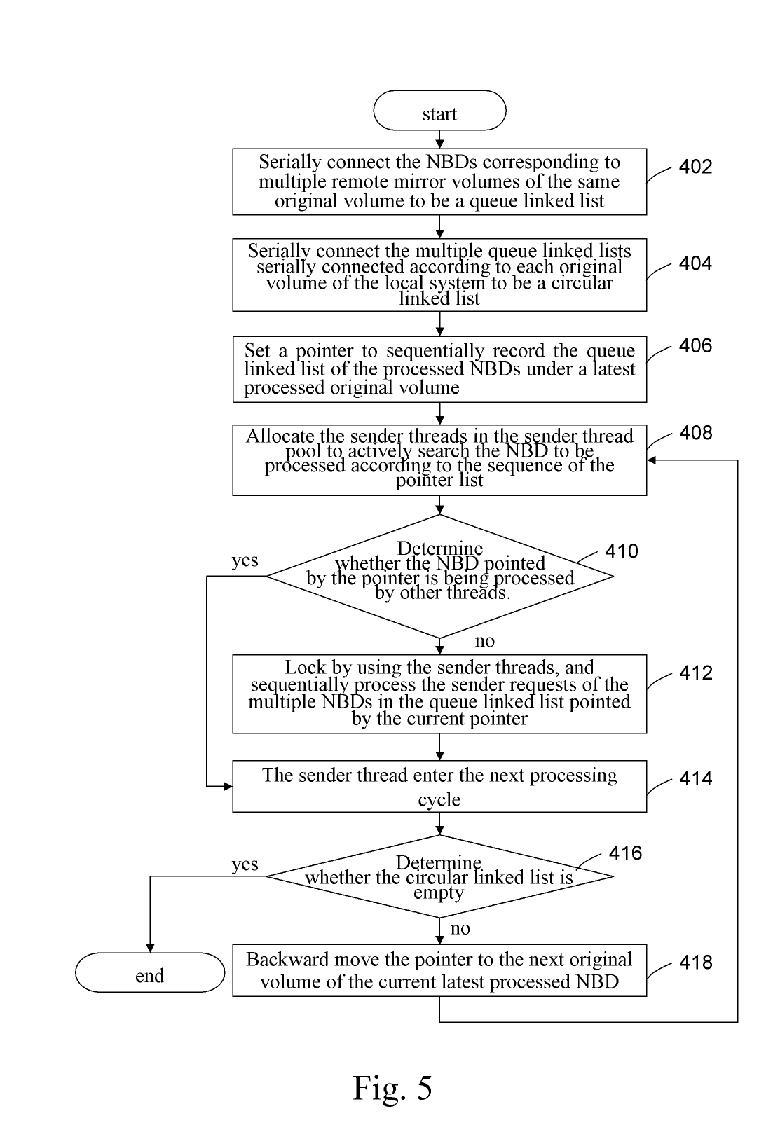

The method of processing sender requests for remote replication provided by the present invention will be illustrated by referring to FIGS. 4 and 5. FIG. 4 is a flow chart of the steps of the method of processing sender requests for remote replication according to the first embodiment of the present invention; and FIG. 5 is a flow chart of the steps of the method of processing sender requests for remote replication according to the second embodiment of the present invention.

As shown in FIG. 4, the method of processing sender requests for remote replication according to the first embodiment of the present invention includes the following steps. A fixed number of (e.g., m) sender threads are created in the local system to form a sender thread pool (Step 302). In this embodiment, the sender threads are allocated by using the remote mirror volume as a unit, i.e., only one NBD is created in each original volume in the local system, and each remote mirror volume corresponds to only one NBD.

All the NBDs (the corresponding number is n and m<n) receiving a write request to the corresponding remote mirror volumes (the number is n) of the remote system are serially connected to be a circular linked list (Step 304). A pointer is set to sequentially record the latest processed NBD in the circular linked list, in which a start position of the pointer points to a list head of the circular linked list (Step 306). Then, the sender threads in the sender thread pool are allocated, so as to actively search the NBD to be processed according to a sequence in the circular linked list (Step 308), thereby processing the sender request of one NBD in the linked list to the corresponding remote mirror volume by using the sender thread.

The sender thread determines whether the NBD pointed by the current pointer is being processed by other sender threads (Step 310), if it is being processed by a thread, the procedure enters the next processing cycle (Step 314), otherwise, the NBD is locked by the sender thread and the sender request queue of the NBD is processed (Step 312). Then, after the request is processed, whether the circular linked list is empty is determined (Step 316), if the linked list is empty, the procedure is ended, and if the linked list is not empty, it is represented that the latest processed NBD currently pointed by the pointer is still followed by NBDs with unprocessed requests. Therefore, the procedure proceeds to Step 308, in which the threads are allocated and the pointer is moved to point to an NBD next to the latest processed NBD, and the determining operation and request processing operation are repeated till the list is empty, i.e., till no NBD in the request queue need be processed, the sender threads are in a waiting state, and the process is ended.

FIG. 5 shows the method of processing sender requests for remote replication in the second embodiment, which is different from the first embodiment in that, this embodiment is applied in a local system in which multiple remote mirror volumes are established in each original volume (each remote mirror volume corresponds to one NBD). That is, the local system 100 includes multiple original volumes, and each original volume includes multiple NBDs, so as to correspond to the created multiple remote mirror volumes. When a certain original volume has a large amount of remote mirror volumes, the sender threads may merely process the data sender requests of the NBD corresponding to the remote mirror volume in the same original volume under most circumstances. Therefore, other original volumes have few opportunities to be processed. At this point, the sender threads are allocated by using the original volume as a unit in this embodiment, so as to make all remote mirror volumes of the original volumes have substantially the same opportunity to be processed.

Therefore, as shown in FIG. 5, different from the circular linked list of the NBDs in the first embodiment, herein, the NBDs corresponding to the multiple remote mirror volumes in the same original volume are serially connected to be a queue linked list (Step 402), and then the original volumes each including multiple serially connected queue linked lists are serially connected to be a circular linked list (Step 404).

Different from the first embodiment, the pointer is set to sequentially record the queue linked list of the NBDs under a certain latest processed original volume in the circular linked list (Step 406). Then, the sender threads in the sender thread pool are allocated (Step 408), so as to actively search the NBD to be processed according to the sequence of a pointer linked list. Herein, the number of the sender threads should better be smaller than the number of the original volumes in the circular linked list, so as to reduce the resource consumption when the sender requests are processed.

When the sender threads are executed, the same as the first embodiment, firstly whether the NBD pointed by the pointer is being processed by other sender threads is determined (Step 410), if it is being processed by a thread, the sender thread enters the next processing cycle (Step 414); otherwise, the processing of the multiple NBDs in the queue linked list of the original volume is locked by using the sender threads and the sender request queue of the multiple NBDs in the queue linked list pointed by the current pointer is sequentially processed (Step 412). Then, the sender thread enters the next processing cycle (Step 414). When the requests are processed, whether the circular linked list of the devices is empty is determined (Step 416), if the list is not empty, the pointer is backward moved to the next queue linked list including multiple NBDs corresponding to the multiple remote mirror volumes of the same original volume (Step 418). Then, the procedure proceeds to Step 408, the threads are allocated and the pointer is moved to point to the NBD of the original volume next to the latest processed NBD, the determining operation and request processing operation are repeated till the linked list is empty.

Similar to the first embodiment, herein, each time when the sender requests in the queue linked list of the NBDs under a certain latest processed original volume are finished, the determining operation of the linked list is repeated in the same manner, and according to the sequence of the original volumes in the circular linked list, the pointer is sequentially moved to a next queue linked list of the multiple NBDs corresponding to the multiple remote mirror volumes of the same original volume, so as to position the next request to be processed till the linked list is empty, i.e., till the sender requests in all the NBDs in the linked list are processed.

The method of processing the sender threads is similar to that in the first embodiment. Each time when the current pointer is moved, one unit of requests of all the remote mirror volumes in the same original volume is sequentially processed and then the procedure enters the next position. Herein, the batch size of the sender requests of the NBDs of each original volume to the remote mirror volumes is allocated according to a unit value, thereby providing different sender request processing capacities for different remote mirror volumes. The unit value depends on the weight set for the original volume, and if the weight is increased, it is represented that there are more resources allocated for the original volume.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system of processing sender requests for remote replication, applied in a local system having a plurality of NBD, the system comprising:
a creation module, for creating a fixed number of sender threads in the local system to form a sender thread pool;
a linked list module, for serially connecting all the NBDs receiving a write request to a corresponding remote mirror volume to be a circular linked list;
a pointer module, for setting a pointer to sequentially record latest processed NBD in the circular linked list and sequentially move the pointer to a next NBD according to the sequence of the NBDs in the circular linked list each time when the sender request of the latest processed NBD is finished, wherein a start position of the pointer points to a list head of the circular linked list;
a thread allocation module, for allocating the sender threads in the sender thread pool to actively search the next NBD to be processed;
a request receiving module, for receiving a new sender request and adding the new sender request to a sender request queue of a corresponding NBD; and
a request processing module, for locking the processing of the next NBD pointed by the pointer by using the sender thread, and processing the sender request of the next NBD.

2. The system of processing sender requests for remote replication as claimed in claim 1, wherein when multiple remote mirror volumes are created in each of original volumes of the local system, the linked list module is further used for serially connecting the NBDs corresponding to the multiple remote mirror volumes belonging to the same original volume to be a queue linked list, and serially connecting the multiple queue linked lists serially connected for each original volume of the local system to be a circular linked list.

3. The system of processing sender requests for remote replication as claimed in claim 2, wherein the request processing module sequentially processes the sender requests of the multiple NBDs in the queue linked list pointed by the pointer to the corresponding remote mirror volume after the locking operation.

4. The system of processing sender requests for remote replication as claimed in claim 3, wherein the pointer module is used to backward move the pointer to a next queue linked list having the NBDs corresponding to multiple remote mirror volumes of the same original volume after finishing the sender requests of the multiple NBDs in the queue linked list.

5. The system of processing sender requests for remote replication as claimed in claim 2, further comprising a weight module for setting sender request weight for each of the original volumes in the local system to allocate a batch size of the sender requests for the NBDs of each original volume to the corresponding remote mirror volume.

6. A method of processing sender requests for remote replication, applied in a local system having a plurality of NBDs, the method comprising:
creating a fixed number of sender threads in the local system to form a sender thread pool;
serially connecting all the NBDs receiving a write request for a corresponding remote mirror volume to be a circular linked list;
setting a pointer to sequentially record a latest processed NBD in the circular linked list, wherein a start position of the pointer points to a list head of the circular linked list;
allocating the sender threads in the sender thread pool to actively search the NBD to be processed pointed by the pointer according to a sequence in the circular linked list;
locking the processing of the NBD pointed by the pointer by using the sender thread, and processing the sender request of the NBD; and
according to the sequence of the NBDs in the circular linked list, each time when the sender request is finished, sequentially moving the pointer to a next NBD and executing the sender request of the corresponding NBD.

7. The method of processing sender requests for remote replication as claimed in claim 6, wherein the step of backward moving the pointer further comprises:
when the pointer points to the latest processed NBD, determining whether the circular linked list is empty;
if the circular linked list is not empty, backward moving the pointer to a next NBD of the latest processed NBD; and
if the circular linked list is empty, ending the processing of the sender request.

8. The method of processing sender requests for remote replication as claimed in claim 6, wherein multiple remote mirror volumes are created in each original volume of the local system, the step of serially connecting the NBDs to be a circular linked list further comprises:
serially connecting the NBDs corresponding to the multiple remote mirror volumes belonging to the same original volume to be a queue linked list; and
serially connecting the multiple queue linked lists serially connected for each original volume of the local system to be a circular linked list.

9. The method of processing sender requests for remote replication as claimed in claim 8, wherein the step of processing the sender request of the NBD pointed by the pointer further comprises:
locking the processing of multiple NBDs in the queue linked list pointed by the pointer by using the sender thread, and sequentially processing the sender requests of the multiple NBDs in the queue linked list to the corresponding remote mirror volumes; and
backward moving the pointer to a next queue linked list having the NBDs corresponding to multiple remote mirror volumes of the same original volume after finishing the sender requests of the multiple NBDs in the queue linked list.

10. The method of processing sender requests for remote replication as claimed in claim 9, wherein further comprising a step of setting a sender request weight for each original volume in the local system to allocate a batch size of the sender requests for the NBDs of each original volume to the corresponding remote mirror volumes.
